(19) United States
(12) Patent Application Publication
(10) Pub. No.: US 2009/0092119 A1
(43) Pub. Date: Apr. 9, 2009

(54) BLIND-SLOT RADIO WITH NON-BLIND-SLOT SCANNING MODE

(75) Inventor: Otmar Rengert, Nurimbag (DE)

Correspondence Address: VENABLE LLP, P.O. BOX 34385, WASHINGTON, DC, 20043-9998, US

(73) Assignee: DSP GROUP SWITZERLAND AG, Zurich (CH)

(21) Appl. No.: 12/158,433

(22) PCT Filed: Dec. 20, 2006
(86) PCT No.: PCT/IB2006/054963

§ 371 Date: Oct. 28, 2008

(30) Foreign Application Priority Data
Dec. 21, 2005 (NL) 05112628.2

(51) Int. Cl. H04J 3/00

(52) U.S. Cl. 370/345

(57) ABSTRACT

The present invention relates to a transceiver device and a method of controlling a time-division multiplex frame structure with time slots in active mode in which a bearer is established, and time slots in an idle mode in which no bearer is established. Adjacent first and second time slots are set in a scanning mode when the transceiver device is listening for bearer set-up attempts, and the first time slot is switched from the scanning mode to the idle mode if a bearer has been established in the adjacent second time slot and the adjacent second time slot is set into the active mode. Thereby, a non-blind-slot scanning mode is provided which enables maximum number of active full and double slots in systems with blind slot radio.

The present invention relates to a transceiver device and method of controlling a time-division multiplex frame structure with time slots in an active mode in which a bearer is established, and time slots in an idle mode in which no bearer is established. In particular, the present invention relates to a fixed part of a cordless communication system according to the Digital Enhanced Cordless Telecommunications (DECT) standard.

Cordless communication systems typically include at least one portable part (or handset or mobile station) coupled via a radio connection to a fixed part (or base station). The fixed part is usually connected by wire to a telecommunications network, such as a traditional Public Switched Telephone Network (PSTN) or an Integrated Services Digital Network (ISDN).

The DECT standard is a cordless standard defined as a Multi Carrier (MC), Time Division Multiple Access (TDMA), Time Duplex Division (TDD) system. The DECT standard is discussed generally in Jerry D. Gibson, “The Communications Handbook”, CRC Press 1997. According to the DECT standard, time is divided into frames of 10 ms. Additionally, each individual frame is divided into 24 full slots. The DECT standard also allows for slots of different lengths including half slots of data (half the length of a full slot) and double slots of data (double the length of a full slot). Provision of different slot types within the DECT standard allows use with different services having different data rates. For example, in DECT/ISDN applications, both full and double slots are utilized to provide ISDN service via a DECT network. The TDMA structure is repeated in frames of 10 ms, each carrying 11,520 symbols, so that data is transmitted at a symbol rate of 1,152 ksymbol/s. The first half of a frame is used to transmit from the fixed part and the second half of a frame is used to receive at the fixed part. Within each frame a structure of 24 full slots may be created. The DECT standard double slot has a length of two full slots, and starts concurrently with a full slot, as described in the ETSI (European Telecommunications Standard Institute) specification EN 300 175-2. Transmission or reception in each slot is done on a channel determined by the carrier frequency and slot position within the frame.

Furthermore, the fixed part maintains a so-called “idle receiver scan sequence”, i.e. in every slot of the 12 full slots in the receiving half of the frame, the receiver in the fixed part is either active, or scanning, or blind (idling), as described in chapter 11.8 of the above ETSI specification EN 300 175-2. The receiver is active if it is receiving a traffic or connectionless bearer used by that radio fixed part (RFP). The receiver is scanning when it is listening for bearer set-up attempts on physical channels. If the receiver is active on a particular slot, it will be unable to listen in that slot on a different RF (radio frequency) carrier. Blind is a non-preferred state. It implies that the RFP is not scanning for any (more) bearer set-up attempts. In general, the term “bearer” used herein designates any telecommunications media that allows transmission of user-information signals between user network interfaces.

In the scanning mode, respective slots listen for bearer set-up attempts from portable parts. The carrier frequency on which this scan is performed changes every frame but is the same on all slots of the same frame, and the sequence is known by the portable part. The fixed part also keeps the portable part informed about which slots are in scanning mode. If a portable part needs to establish a bearer it chooses a non-interfered channel (given by frequency and slot position or number) and transmits on the chosen slot, when the receive scan sequence reaches the chosen carrier. Once a correct set-up message is detected by the fixed part, an acknowledge message is returned on the corresponding transmission slot to the portable part (separated by 12 slots, i.e. one half frame), and the corresponding slot is switched to the active mode. Thereafter, the frequency on this slot is fixed. In RFPs which for cost reasons only have one receiver, it is not possible to listen on a different RF carrier in a specific slot, if the receiver is already active on this slot.

Most commercial DECT equipments for residential applications (e.g. normal cordless phones), use so-called “blind-slot radios”. These radios do not allow adjacent slots to be active. The so-called “blind slot” is required in blind-slot radios to receive programming information and to set-up the correct carrier frequency. The carrier frequency is obtained from a voltage controlled oscillator (VCO) controlled by a phase locked loop (PLL). Consideration of possible leakage current(s) into a PLL charge-pump, associated capacitors and the active slot duration forces a time constant (reaction time) to be chosen, which basically corresponds to a slot duration. During this period (i.e. the slot before the active slot) the blind-slot radio cannot be used to receive or transmit. Consequently, for a fixed part with a blind-slot radio every active slot has adjacent blind slots which cannot be used. As a result, the fixed part with a blind-slot radio can in total only have 12 active slots (i.e. 6 transmit plus 6 receive slots), rather than 24 slots that are theoretically available. Reasons for using such kind of radios is that they are much cheaper than radios where all slots can be active at the same time (so-called “non-blind slot radios”) and that in residential voice applications this provides sufficient bandwidth.

Due to the above restrictions, conventional implementations for receiver scan schemes in DECT fixed parts with blind-slot radio are adapted to scan only on even slots or only on odd slots.

FIG. 2 shows a schematic diagram indicating 12 full slots (slot No. 12 to 23) of the receiving half of a DECT frame, wherein “SS” indicated the scanning mode during scanning or set-up, and “BB” indicates the blind mode to allow VCO settling. For standard DECT fixed parts supporting full slots only, this blind-slot scanning mode is not a real disadvantage, as with such a blind-slot radio it is only possible for every second slot to be in an active mode anyway.

However, when using a fixed part with double-slot format, these double slots occupy two standard full slots. Using a blind-slot radio with blind-slot scanning mode would thus lead to reduced efficiency.

Chung-Ming Yuen et al., “An Ultra-Fast Locking Frequency Synthesizer Algorithm for Zero Blind Slot Communication in Digital European Cordless Telephone (DECT)”, IEEE, 1997, describes an algorithm of a fast locking phase locked loop frequency synthesizer designed for a DECT system, wherein the frequency synthesizer can lock at any DECT channel within 48 μs guard time. This provides the capability of zero blind slot operation where all time slots are fully usable for data transmission and no time slot is required for channel switching.

It is an object of the present invention to provide a transceiver device with improved frame structure and a control method, by means of which optimum medium efficiency can be achieved for both full- and double-slot types.

This object is achieved by a transceiver device as claimed in claim 1 and by a method of controlling a time-division multiplex frame structure, as claimed in claim 7.

Accordingly, a scanning scheme is suggested in which neighboring slots can be scanned so as to allow the radio transceiver station (e.g. DECT fixed part) to listen in all slots for bearer set-up attempts from portable parts, while adjacent scanning slots are at the same frequency. Maximum number of active full and double slots can thus be allowed even in systems with blind-slot radio transceivers.

The controller means may be arranged to set all slots of the frame structure into the scanning mode when the radio transceiver station is listening for bearer set-up attempts. Thereby, portable parts can set-up bearers in all slots, so that efficiency and flexibility is increased.

Furthermore, the controller means may be arranged to provide a double-slot format, wherein double slots are used in the active mode, the double slots occupying two adjacent time slots separated by a single-time slot in the idle mode. This allocation scheme provides the maximum number of double slots on a system with blind-slot radio, wherein the proposed scanning scheme enables the required three consecutive slots in the scanning mode. In particular, the controller means may be arranged to support both single-slot format and double-slot format. Due to the proposed non-blind scanning mode, even both slot formats can be supported.

The present invention will now be described based on a preferred embodiment with reference to the accompanying drawings in which:

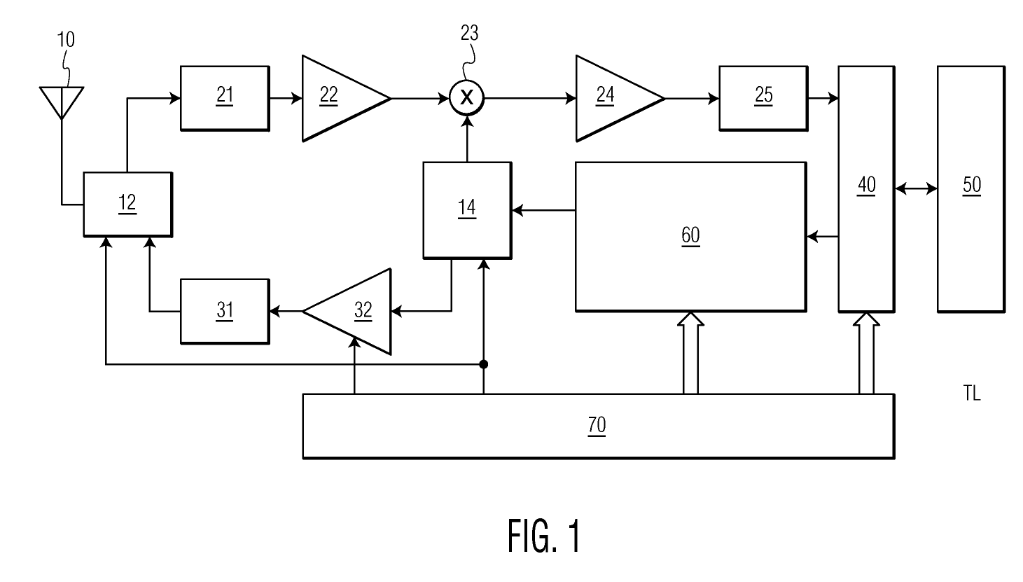

FIG. 1 shows a schematic block diagram of a transceiver device according to the preferred embodiment;

FIG. 2 shows a schematic table indicating slot allocation in a conventional blind-slot scanning mode; and

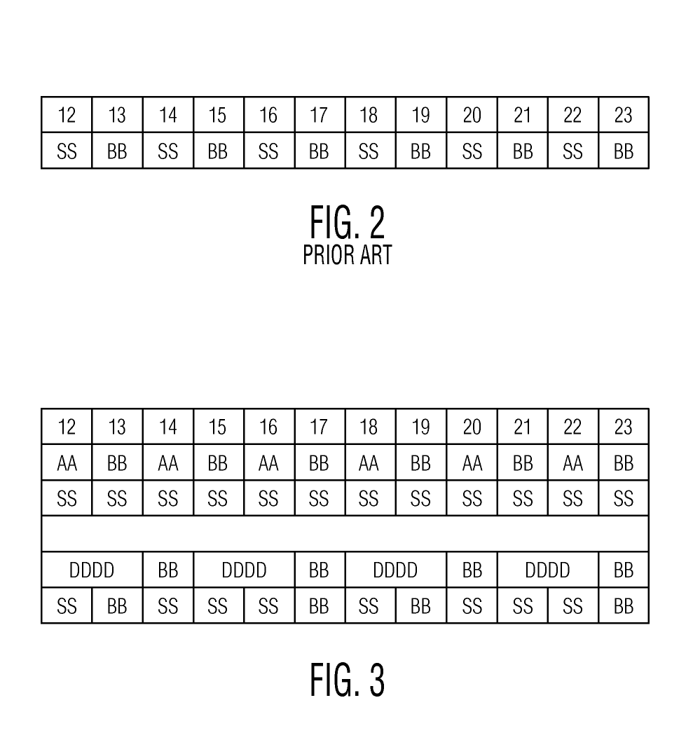

FIG. 3 shows a schematic table indicating slot allocations in a scanning mode according to the preferred embodiment.

In the following, the preferred embodiment will be described on the basis of a DECT fixed part (base station).

FIG. 1 shows a schematic block diagram of the DECT base station, wherein an antenna 10 is provided for receiving and transmitting RF signals in a predetermined TDMA scheme on different transmission frequencies or carriers. A transmit and receive section work alternatively based on a switching operation of an Rx/Tx-switch 12. When the base station is transmitting, a user signal received via a telephone line interface 50 is coded by a codec 40 and modulated on a carrier generated by a frequency synthesizer 60. The frequency synthesizer 60 may comprise a PLL loop, for example. In the transmitting mode, another switch 14 is switched to connect the frequency synthesizer 60 to a power amplifier 32 so as to forward the modulated carrier via a transmission filter 31 and the Tx/Rx-switch 12 to the antenna 10 for transmission. When the system is receiving, the Tx/Rx-switch 12 switches the radio signal received via the antenna 10 to a reception filter 21 and a subsequent low noise amplifier 22. During reception, the frequency synthesizer 60 is connected via the other switch 14 to a mixer 23 and generates a local oscillator signal to be injected into the mixer 23. The difference frequency or intermediate frequency (IF) at the output of the mixer 23 is supplied to an IF amplifier 24 and a subsequent demodulator 25. The demodulator 25 separates the user signal from the carrier and supplies it to the codec 40, where the original user signal is decoded and supplied to the telephone line interface 50 for transmission via a telephone line TL.

All timing, synchronization and the frequency synthesizer 60 is controlled by a burst mode controller 70. During transmit operations, the burst mode controller 70 is operable to access the user or data signal from the telephone line interface 50 at appropriate timing within the TDMA frame. In particular, the burst mode controller 70 is configured to allocate time slots and carrier frequencies in compliance with the DECT standard. During receive operations, the burst mode controller 70 is operable to convert received time slots into a continuous user or data signal for application to the telephone line interface 50. To achieve this, the burst mode controller 70 applies control signals to the Tx/Rx-switch 12, the power amplifier 32, the other switch 14, the frequency synthesizer 60 and the codec 40.

The proposed scanning scheme according to the preferred embodiment is based on a scanning mode in which all slots are set by the burst mode controller 70 on the same carrier, so that the VCO provided in the PLL of the frequency synthesizer 60 does not need the blind time slot between scanning slots, since the frequency of adjacent slots in scanning mode does not change. This allows the proposed transceiver station, i.e. DECT base station, to be set-up with a blind-slot radio that has no time slots in the blind mode. Portable parts or handsets can thus be set-up in all slots. Once a bearer is established and the respective slot is set into the active mode, the burst mode controller 70 performs control so as to switch the adjacent slots to the blind mode, because then the frequency of the active slot will be different from the slots in the scanning mode in most frames.

This proposed non-blind-slot scanning mode increases efficiency when using the DECT double-slot format. The double slots occupy two standard full slots. Using a blind-slot radio, maximum medium efficiency can be achieved by using active double slots, separated by a single blind full slot only, so as to allow for four double slots per half frame.

FIG. 3 shows a schematic table indicating time slots of a receiving half of a DECT frame with a maximum number of six full slots in the second row of the table, and a maximum number of four double slots in the third row of the table, wherein both full slots and double slots are separated by a full slot in blind mode. The third and fourth row of the table indicate proposed scanning schemes according to the preferred embodiment, in which adjacent time slots can be set to the scanning mode without any intermediate slots in the blind mode. In the preferred embodiment of FIG. 1, the proposed scanning scheme is obtained by a corresponding control operation of the burst mode controller 70.

A blind-slot radio fixed part as shown for example in FIG. 1 may thus support both full and double slots in the same frame, wherein the slot type depends on the set-up message received from the portable part. Using the preferred embodiment, optimum medium efficiency can be achieved for both slot types if the proposed non-blind-slot scanning mode is used. This can be seen from the receiving half frame depicted in FIG. 3, where both full and double slots are supported with maximum number of active full slots in the first row and maximum number of active double slots in the third row. Each full slot (“AA”) and double slot (“DDDD”) in active mode can be set on a different frequency, wherein intermediate slots in blind mode (“BB”) are provided to allow VCO settling. The opportunity of providing adjacent slots in scanning mode (“SS”) when no slot is active allows set-up of any full or double slot.

It can thus be seen that the maximum number of active full and double slots can be provided even in a system with blind slot radio. In particular, the proposed non-blind-slot scanning mode is essential for maximum number of double slots due to the fact that three consecutive slots must be set into the scanning mode.

It is however noted, that the preferred embodiment is not limited to the above DECT configuration. It is applicable to any radio transceiver station and control method for a time-division multiplex frame structure using time slots in an active mode and in an idle or blind mode. The preferred embodiment may thus vary within the scope of the attached claims.

In summary, a radio device and a method of controlling a time-division multiplex frame structure with time slots in active mode in which a bearer is established, and time slots in an idle mode in which no bearer is established, have been described. Adjacent first and second time slots are set in a scanning mode when the transceiver device is listening for bearer set-up attempts, and the first time slot is switched from the scanning mode to the idle mode if a bearer has been established in the adjacent second time slot and the adjacent second time slot is set into the active mode. Thereby, a non-blind-slot scanning mode is provided which enables maximum number of active full and double slots in systems with blind slot radio.

Finally but yet importantly, it is noted that the term “comprises” or “comprising” when used in the specification including the claims is intended to specify the presence of stated features, means, steps or components, but does not exclude the presence or addition of one or more other features, means, steps, components or group thereof. Further, the word “a” or “an” preceding an element in a claim does not exclude the presence of a plurality of such elements. Moreover, any reference sign does not limit the scope of the claims.

1. A transceiver device for radio transmission by using time-division multiplex, said transceiver device comprising:
controller means for providing a time-division multiplex frame structure with time slots in an active mode in which a bearer is established, or an idle mode in which no bearer is established,
wherein said controller means are arranged to set adjacent first and second time slots in a scanning mode when said transceiver device is listening for bearer set-up attempts and to switch said first time slot from said scanning mode to said idle mode if a bearer has been established in said adjacent second time slot and said adjacent second time slot is set into said active mode.

2. A transceiver device according to claim 1, wherein said controller means are arranged to set all slots of said frame structure into said scanning mode when said transceiver device is listening for bearer set-up attempts.

3. A transceiver device according to claim 1, wherein said controller means are arranged to provide a double-slot format, and wherein double slots are used in said active mode, said double slots occupying two adjacent time slots separated by a single time slot in said idle mode.

4. A transceiver device according to claim 3, wherein said controller means are arranged to support a single-slot format and said double-slot format.

5. A transceiver device according to claim 1, wherein said controller means comprise a burst mode controller.

6. A transceiver device according to claim 1, wherein said transceiver device is a base station according to the Digital Enhanced Cordless Telecommunications (DECT) standard.

7. A method of controlling a time-division multiplex frame structure with time slots in an active mode in which a bearer is established, and time slots in an idle mode in which no bearer is established, said method comprising the steps of:
a) setting adjacent first and second time slots in a scanning mode when said radio transceiver station is listening for bearer set-up attempts; and
b) switching said first time slot from said scanning mode to said idle mode if a bearer has been established in said adjacent second time slot and said adjacent second time slot is set into said active mode.
